(19) United States
(12) Patent Application Publication
(10) Pub. No.: US 2009/0198622 A1
(43) Pub. Date: Aug. 6, 2009

(54) Interactive System And Method For Transacting Business Over A Network

(76) Inventors: John D. Temte, Boulder, CO (US); Matthew S. Etlinger, Denver, CO (US); Timothy Newcomb, Boulder, CO (US)

Correspondence Address: LATHROP & GAGE LLP, 4845 PEARL EAST CIRCLE, SUITE 201, BOULDER, CO, 80301, US

(21) Appl. No.: 12/363,584

(22) Filed: Jan. 30, 2009

Related U.S. Application Data
(63) Continuation-in-part of application No. 11/684,155, filed on Mar. 9, 2007.
(60) Provisional application No. 61/024,647, filed on Jan. 30, 2008.
(60) Provisional application No. 60/781,212, filed on Mar. 10, 2006.

(51) Int. Cl. G06Q 30/00; G06Q 99/00; G06F 15/16; G06F 17/30

(52) U.S. Cl. 705/80; 705/1; 709/206; 705/34; 709/204; 707/3; 707/E17.014

(57) ABSTRACT

A method of doing business includes allowing an individual to start a group, or Swarm, for the purpose of influencing a sale before purchasing a desired product or a service. The group is recorded in a searchable computer database such that additional individuals may join the group, and potential sellers can search the computer database to determine which groups seek products or services they have for sale. Sellers then submit offers for products or service to the group, the offer being recorded in the computer, where individuals of the group may view and may accept the offer. Once an offer is accepted, a transaction is consummated between the individual and the seller based on the accepted offer.

### RELATED APPLICATIONS

This application claims benefit of priority to U.S. Provisional Patent Application Ser. No. 61/024,647 filed Jan. 30, 2008, and is a continuation-in-part of U.S. patent application Ser. No. 11/684,155 filed Mar. 9, 2007, claiming benefit of priority to U.S. Provisional Patent Application Ser. No. 60/781,212 filed Mar. 10, 2006. Each of the aforementioned patent applications are incorporated herein by reference.

### FIELD OF THE INVENTION

The present invention relates to a system for transacting business over a network. More particularly, the system allows multiple interested buyers to organize and collectively influence prices from potential sellers and/or service providers.

### BACKGROUND

Companies and individuals utilize various methods to transact business over the Internet. Most online shopping resembles traditional shopping experiences with the exception that the goods are shown to potential buyers over the Internet and are delivered by carriers after the transaction is finalized.

Other methods of Internet business transaction include online auctions and the likes held by eBay. The eBay business method allows individual sellers to post an item for sale on eBay's website along with a starting bidding price. The seller may also specify the time when the auction is to end.

Although these various methods allow buyers and sellers to interact in an auction and auction-like environment before completing a business transaction, none of them facilitate collective bargaining power among a related group of buyers, such as affording buyers with similar needs an opportunity to collectively bargain with potential sellers in order to obtain a group discount. It is desirable to provide online shoppers with a mechanism to bargain collectively for lower prices or other advantages. From the seller's perspective, there is a need for a more efficient way to deal with a group of potential buyers such that large volume of sale may be achieved with minimal transactional cost.

### SUMMARY

The eSwarm system and method reported herein operate on programmable circuitry, using transmissions across one or more networks to facilitate joint interactions among user communities that share aligned interests. In particular, potential buyers to associate as a group that collectively influences potential sellers. More particularly, the disclosed method enables an individual consumer or ‘eSwarmer’ to start a group, or join an existing group, that is referred to herein as a “Swarm.” The Swarm may grow to a size that is sufficient to attract the attention of potential sellers who may adjust their sales practices to accommodate the needs of the Swarm, or a portion of the Swarm, such as by offering product at a particular price.

The Swarm targets a product or service, together with other details such as location of bulky or unshipable goods or services. In starting or joining a Swarm, a consumer seeks to attract to his or her Swarm as many like-minded consumers as possible to grow the Swarm. By their aggregating separate purchases into a single aggregated value as a ‘buying Swarm,’ these consumers entice potential sellers to offer sales prices to the sometimes large group of “hot leads” represented by Swarms.

In various aspects, Consumers may join Swarms on a central host machine, or indirectly in a distributed way via eSwarm Widget software that is installed on a third-party website. Any eSwarmer (consumer, seller or third-party website administrator) may start or join a Swarm. In starting a Swarm, a seller seeks to attract to his or her Swarm as many like-minded consumers as possible to grow the Swarm. By aggregating their separate purchases into a single aggregated value as a ‘buying Swarm,’ these consumers entice potential sellers or ‘Swarm-Suppliers to offer sale prices to the sometimes large group of “hot leads” represented by Swarms.

In one embodiment, a logged-in seller sees a desirable Swarm. The seller clicks “Make Offer” and enters data that the eSwarm System uses to notify eSwarmers in that Swarm of the offer. From the “Make Offer” page, a seller:
(A) sees he/she will be charged for each Swarmer who views an offer and an additional charge for each Swarmer who accepts an offer;
(B) selects a billing method for this charge (e.g., Limit by Views, Limit by Acceptance, Limit by Budget);
(C) enters payment information and selects payment type (e.g., credit card or billing agency); and
(D) describes the offer by providing name of product/service, offer expiration, and terms of offer, (e.g. price, shipping costs, color, size, and/or restrictions).

The seller may be limited, such as by allowing only one offer per Swarm. Once notified of an offer, Swarm members avail the network, such as the Internet, view the offer where it resides and decide whether to accept or decline. Those who accept click “accept” and receive the seller's instructions for completing the transaction with the seller and they are removed from the Swarm. Those who decline the offer automatically remain in the Swarm. Swarms expire automatically after a set period of time, such as 30 days, but the eSwarm system may lengthen this time to enable larger Swarms.

In a distributed embodiment, the central host may export software for residence upon a third-party host system to provide an eSwarm Widget, or the software may be separately installed. In one example, by displaying an eSwarm Widget with selected buying Swarms embedded in that Widget, a third-party website administrator seeks to increase the value of his/her site for users by enabling them to Swarm for particular products/services and also to generate revenue from payment by eSwarm to the site for users Swarming via the eSwarm Widget and who view or accept offers.

The growth of a Swarm may eventually lead to sellers to post sales offer, in which a seller pays eSwarm per view and per acceptance of that sales offer. That offer is communicated to all members of the Swarm by eSwarm, including Swarm members who joined via the eSwarm Widget.

### BRIEF DESCRIPTION OF THE FIGURES

FIG. 1 is a block diagram of a system for facilitating commerce.

FIG. 2 is a process diagram of possible buyer actions.

FIG. 3 is a process diagram of possible seller actions.

FIG. 4 is a process diagram of possible user actions, including manager actions.

FIG. 5 illustrates a buyer record of the buyer database 110 of FIG. 1.

FIG. 6 illustrates a Swarm record of the Swarm database 108 of FIG. 1.

FIG. 7 illustrates a seller record of the seller database 112 of FIG. 1.

FIG. 8 illustrates an offer record of the offer database 114 of FIG. 1.

FIG. 9 illustrates actions taken during a typical transaction.

FIG. 10 shows use of an eSwarm Widget on a third-party website.

FIG. 11 shows a buyer interacting with the eSwarm central server through use of an eSwarm Widget on a third-party website.

FIG. 12 shows a buyer interacting with the eSwarm central server to access personal data through use of an eSwarm Widget on a third-party website.

### DETAILED DESCRIPTION OF THE EMBODIMENTS

The following discussion teaches by way of nonlimiting examples. Before the eSwarm System and method are illustrated in greater detail, some terms used in this disclosure are defined for the purpose of clarification.

In a systems context, “eSwarm System” means a platform using an Internet website for consumers to join together with others for their own economic advantage. The platform also permits suppliers to supply products or services to those consumers. In one aspect, the platform may be shared among a plurality of host computers permitting third-party website administrators to enable users to Swarm products or services from the party website. This last functionality may be provided through software referred to herein as an “eSwarm Widget” installed, for example, on social network websites and forums with such focused interests as sports, women's fashion, green products, etc., duplicating in whole or in part the eSwarm System functionality. The eSwarm System charges sellers according to the number of “views” and “acceptances” which that seller's offer experiences, whether directly from the central host or indirectly from eSwarm Widgets included on various third party websites.

In a consumer context, an “eSwarm,” also known as a “Swarm,” refers to a group of eSwarmers, or potential buyers, who have joined together to purchase a particular product or service, either for purely economic reasons or to strengthen their group's economic power. An eSwarm is made up of like-minded consumers who have aggregated their separate purchases into a single and larger buying-Swarm in order to entice sellers, i.e., Swarm-Suppliers, to make sales offers to the Swarm.

“Swarm Duration” means the time frame designated as the expiration time of a Swarm, typically 30 days from creation or the most recent transaction, although the duration of Swarms may differ because of the nature of the product/service being Swarmed. After the Swarm Duration, the Swarms dissolve automatically. Suppliers cannot make offers to a Swarm after it has expired, and each Supplier may make only one offer per Swarm.

An “eSwarmer” refers to a buyer, a third-party website administrator who displays an eSwarm Widget on a website, or a Seller that starts a Swarm or joins a Swarm. As such, the eSwarmer is a member of a community of interest including like-minded persons who have an interest in bringing together a group of persons as a Swarm, or in being a Swarm participant. An eSwarmer is often a consumer, but third-party website administrators or sellers are not excluded from this definition unless specifically noted.

“Buyer” is an eSwarmer who is primarily interested in buying products or services.

“Seller” or “Swarm-Supplier” means a supplier of the product/service sought by an eSwarm (or Swarm), typically a manufacturer, retailer, service provider, drop-shipper, etc.

The term “eSwarm” refers to a stage in the process when a product or a service has been “Swarmed,” i.e., like-minded consumers have formed a group to entice a Swarm-Supplier to supply a Swarm.

“eSwarmable” means any legal product or service that may be eSwarmed.

“eSwarming” or “Swarming” refers to the act of like-minded consumers joining together to aggregate their separate purchases into a single and larger buying-Swarm in order to entice Swarm-Suppliers to sell a designated product at an advantageous price.

An “eSwarm Widget” is a “mini-eSwarm, that a third-party website administrator can generate from eSwarm and display on his/her website. The eSwarm Widget enables the site's users to Swarm for products/services without coming to eSwarm and enables the site to generate revenue from sellers' sales offers which are “view” and “accepted” from site users who joined an eSwarm via that site's Widget.

“Widget Swarms” refers to the act of like-minded consumers joining together, via an eSwarm Widget, to aggregate their separate purchases into a larger buying-Swarm in order to entice Swarm-Suppliers to sell a designated product at an advantageous price.

The term “Join Swarm” means the act of joining an existing Swarm under the terms designated when the Swarm was started.

The phrase “Start a Swarm” refers to the act of starting a Swarm for a particular product or service.

The Phrase “View all Swarms” means the act of reviewing all Swarms on eSwarm's operating platform.

The term “MeSwarm” refers to a personal or private homepage on eSwarm for each eSwarmer that lists Swarms he or she started or joined.

Each Swarm's status regarding description (user-generated content), sales offers (if any) and time remaining for sales offer is also listed. The “MeSwarm” page allows group members to communicate with one another and to be informed about other Swarms started or joined by members of their group.

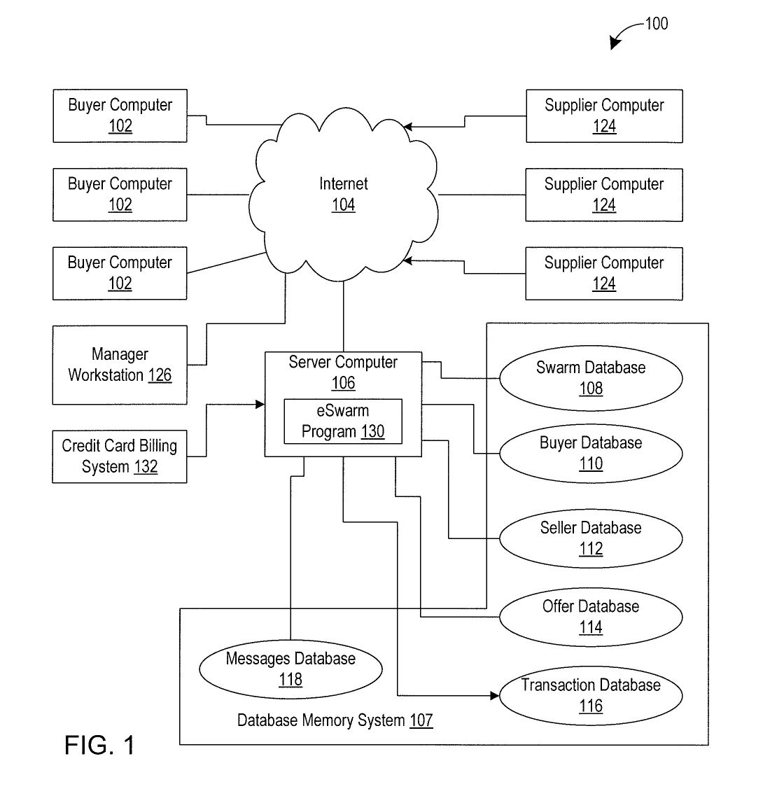

In a particular embodiment of an eSwarm System 100 for transacting business over a network, as illustrated in FIG. 1, there are one or many buyers located at buyer computers 102. A plurality of buyer computers 102 are linked through the Internet 104 to a server 106. The server computer 106 connects to a memory system 107, such as a Redundant Array of Independent Disks (RAID) array, that contains a Swarm database 108, a buyer database 110, a seller database 112, an offer database 114, a transaction database 116, and a messages database 118. One or more sellers use supplier computers 124, and one or more managers use manager workstations 126 to link through Internet 104 to the server computer 106. Server computer 106 has an eSwarm program 130 with machine readable code in memory, and in an embodiment may couple to a credit card billing system 132.

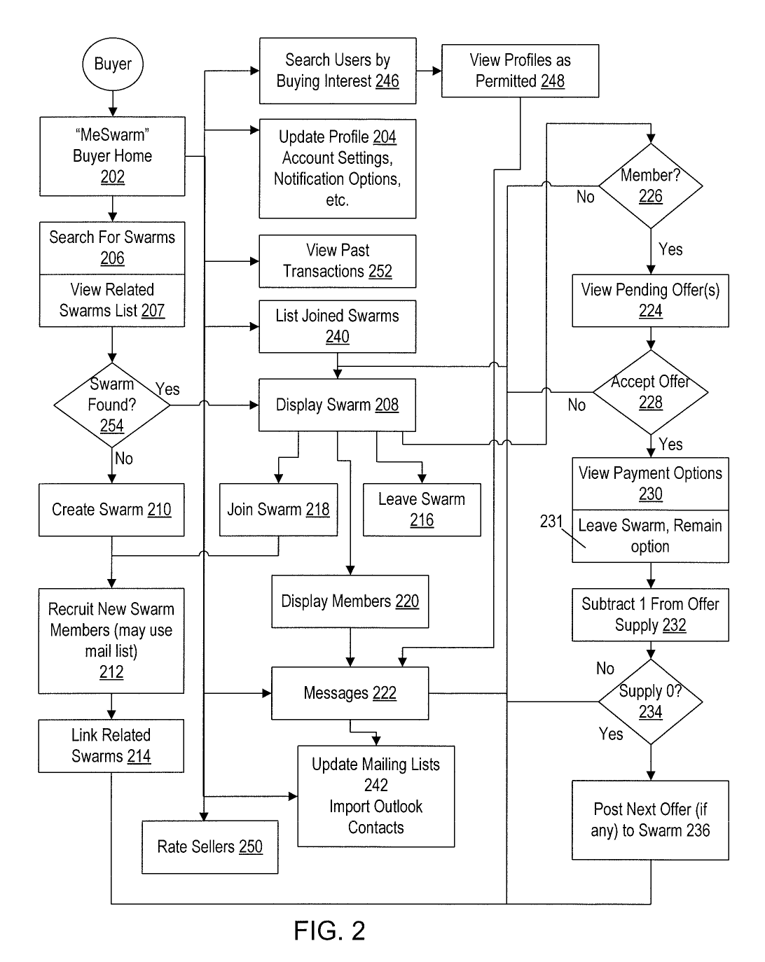

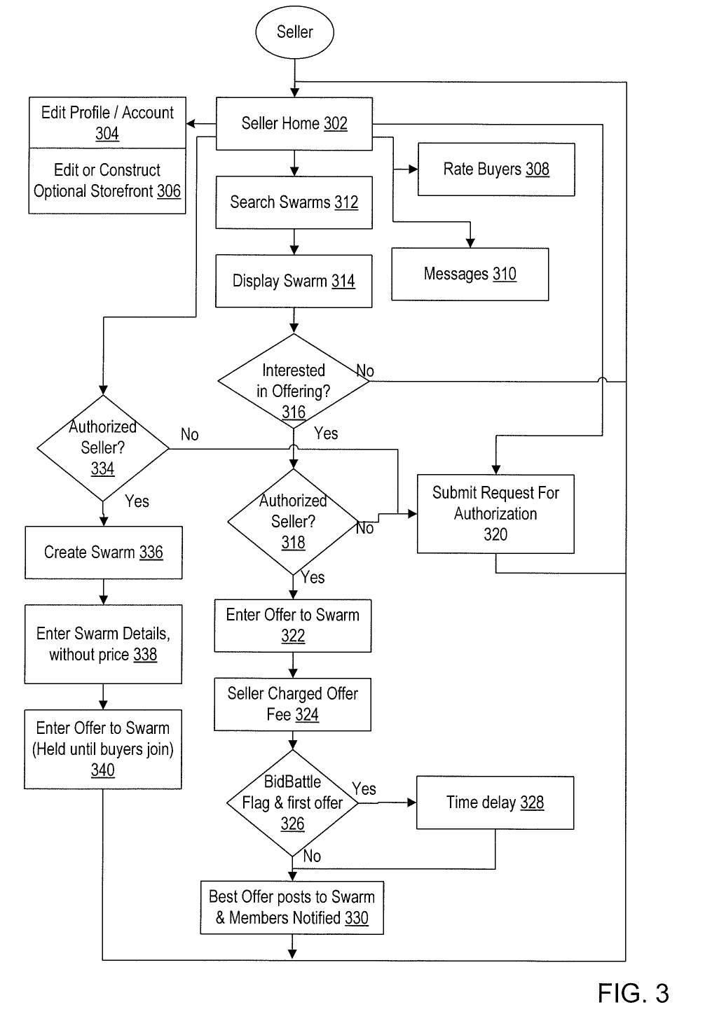

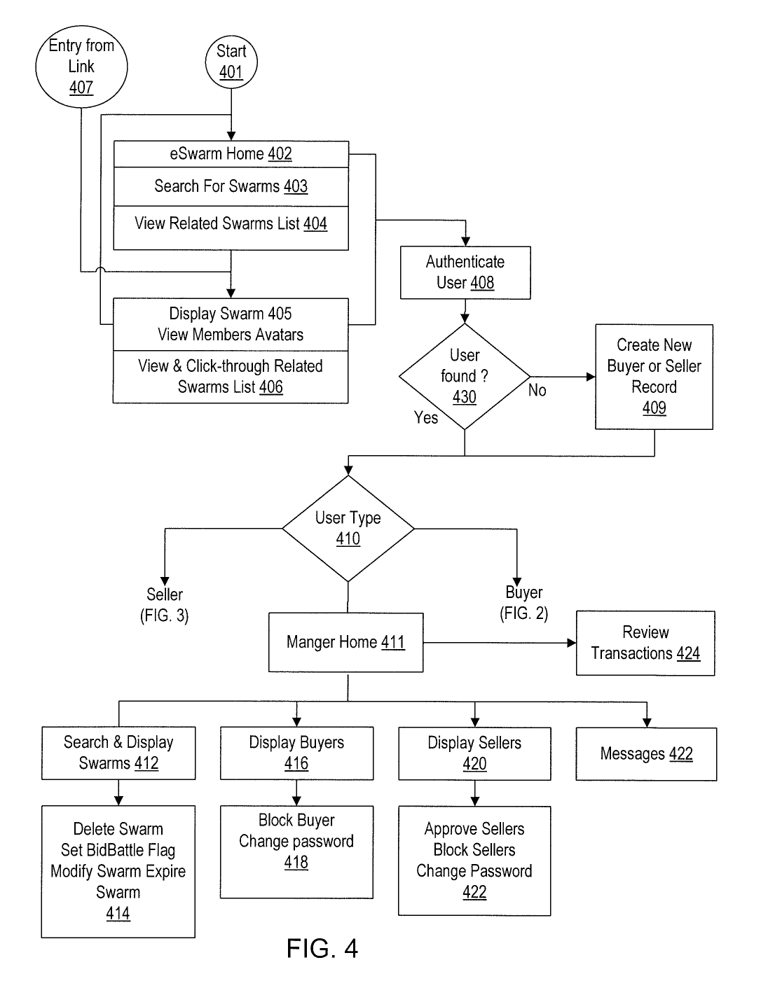

FIGS. 2, 3, and 4 are process diagrams illustrating operation of the eSwarm System according to one embodiment. Under control of the machine readable code of the eSwarm program 130 and machine readable code of an operating system, when a user connects to server computer 106 (FIG. 1) through a buyer computer 102, a supplier through a supplier computer 124, or a manager through a manager workstation 126, that user is initially 401 (FIG. 4) presented with a system homepage 402 that provides an entry to a hierarchical pick list of existing Swarms, as well as opportunities to search Swarms 403. The user may select and display a Swarm 405 through the hierarchical pick list. After a search, or while viewing a Swarm, a related Swarms list is displayed 404; the user may click through to display a Swarm 405. The user may in turn select another Swarm through a related Swarms list 406 of the displayed Swarm, or return to the homepage 401.

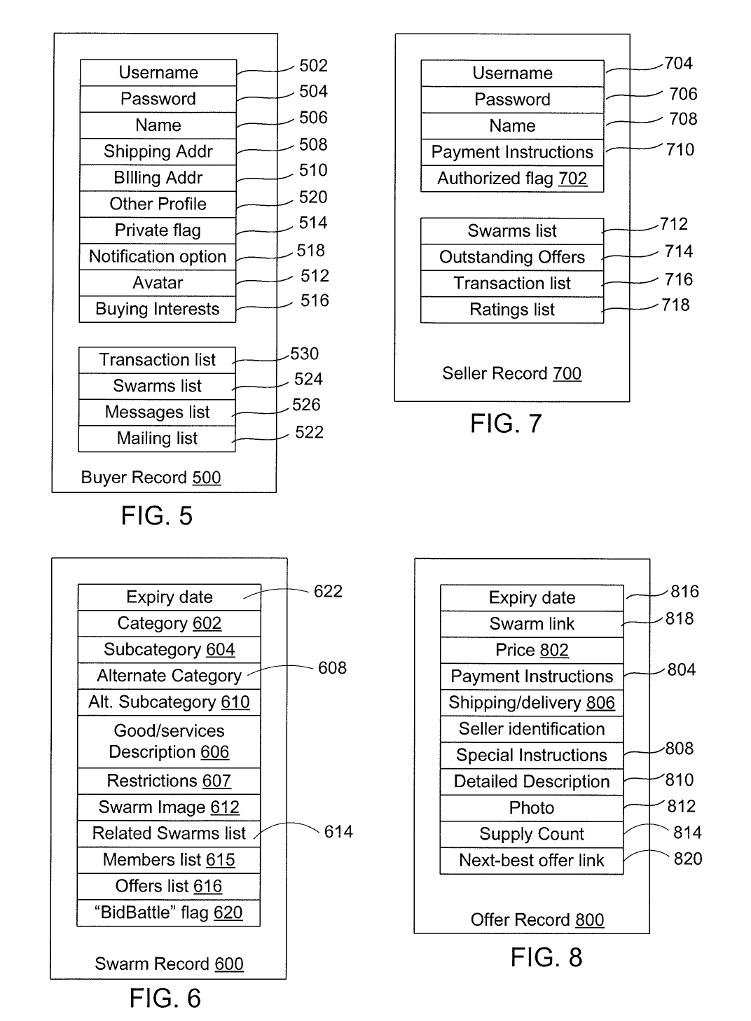

When the user attempts to perform an action forbidden to non-members, or chooses to log into the system, that user is authenticated 408 (FIG. 4) through entry of a user name and password. If 430 that user is not found in the buyer 110, seller 112, or manager (not shown) databases, or, in an alternative embodiment, a unified user database containing bother buyer and seller records, the user is given an opportunity 409 to create a new buyer record (FIG. 5) or seller record (FIG. 7) in the appropriate buyer 110 or sell 112 databases. A new buyer need only provide a username and password; additional buyer record information may be entered later.

Here it should be noted that the database record illustrations of FIGS. 5-8 do not illustrate the various hash tables, trees, and linking required to index and access these databases of FIG. 1; nor do they illustrate the dynamic memory management routines required to allow manipulation of these records. These functions are well known in the art of databases. Further, in alternative embodiments the buyer 110 and seller 112 databases (FIG. 1) may be combined into a single user database having variable or extended records, and the offer database 114 may be merged into the Swarm database 108.

### Buyer Activity

The user type is then identified 410. If the user is a buyer, a buyer “home page,” Widget, or MeSwarm pages, is displayed 202 (see FIG. 2)

In order to join (whether directly on eSwarm or indirectly via an eSwarm Widget or start a Swarm) the buyer must register an account with eSwarm. To register an account with eSwarm, the buyer provides a user name, password, email address, security question and security question answer.

The buyer may optionally update 204 the buyer's profile in his associated buyer record 500 (FIG. 5) on the buyer database 110. The profile includes the buyer's username 502 (FIG. 5) the buyer database 110. The profile includes the buyer's username 502 and password 504, and may at the user's option include an avatar 512 and address book. In one example, profile information may include the buyer's name 506 and password 504, and may at use the user's option include the buyer's name 506, shipping 508 and billing 510 addresses for use during purchases, an avatar image 512, a private flag 514, and buying interests 516. The profile may also contain notification options 518 that indicate how this buyer is to be notified whenever a Swarm he has joined has a posted offer, the notification options 518 may contain email addresses for email notification and cell phone numbers for voice and/or text message notification, together with flags indicating preferred notification methods. There will also be additional profile information 520, including Swarms the buyer has started or joined, and a list of buyers with interests related to those of the buyer so that the buyer may contact them later. The buyer's password may be stored in an encrypted format for security. When done, the buyer is returned to the buyer home page 202. A list of the offers the buyer has accepted may also be presented.

The buyer may then search 206 the Swarm database 108 through either a hierarchical buying-interest pick-list, through keyword searches, or through clicking links in related Swarms for existing Swarms relevant to goods or services that buyer wishes to buy. If 254 any are found, a list of related Swarms 207 is displayed; if no Swarms are found the buyer may repeat the search 206, return to his homepage 202, display an existing Swarm from the list, or may at any point choose to create 210 a new Swarm. A buyer may also search 206 from a Widget on third-party websites.

If the buyer chooses to create 210 a new Swarm, a new Swarm record 600 (FIG. 6) is created in Swarm database 108. While creating 210 the Swarm, the buyer will select a category 602 and subcategory 604 of goods or services he wishes to acquire, and enters a description 606 of the goods or services desired including reasonable restrictions 607 on those goods. For example but not by way of limitation the buyer may create 210 a Swarm in a category 602 “vehicles,” subcategory 604 “SUV,” for goods described 606 as “Jeep Grand Cherokee, New” with restrictions 607 of pickup or delivery in Wyoming. In order to facilitate location of the Swarm by other buyers and sellers, the buyer may optionally enter an alternate category 607 and subcategory 610. This information is placed in a Swarm record 600 in Swarm database 108. When creating 210 a Swarm, a buyer may optionally select or upload a thumbnail Swarm image 212 for the Swarm. When a buyer creates 210 a Swarm, it is assumed that the buyer is joining that Swarm, so the Swarm is linked to a joined Swarms list 524 (FIG. 5) in the buyer's record 500. The eSwarm system may set any expiration date 622.

Once the Swarm is created 210, the buyer is given an opportunity to grow the Swarm by recruiting 212 new members of the Swarm. The buyer may do so by sending email having a message with an automatically generated HTML link to a web page associated with the Swarm, or in an embodiment text messages to cell phones. The buyer may add recipients' receiving addresses on a buyer's MeSwarm page. The buyer may also advertise the Swarm through eSwarm Widgets on third party websites, such as the buyer's Facebook® homepage, and through pasting HTML links into other web pages to which the buyer has access. The emails and text messages are directed to persons who may become additional buyers, and may be addressed either manually or through use of pick boxes associated with entries on the mailing list 522 in the buyer's buyer record 500. Additional messages 526 may be posted into messages database 118 and addressed to other buyers already in buyer database 110 who may be interested in join in the Swarm.

Incentives, such as coupon discounts, may optionally be given to buyers who recruit new members to a Swarm through emails to external systems, through text messages, through HTML links, and eSwarm Widgets because those may attract new buyers to the system 100.

In an embodiment, the buyer is next given an opportunity to link 214 the new Swarm to other, already existing, Swarms related to the new Swarm; for example but not by limitation a user may link a “paint my pickup truck” Swarm to a “paint my sports car” Swarm so that buyers and sellers may find the new Swarm easily after having located the related Swarm. These related Swarms are added to a related Swarms list 614 in the Swarm record 600 in Swarm database 108.

The new Swarm is then displayed 208.

When a Swarm is displayed 208, the buyer may return to his buyer home 202, may delete himself from, or leave 216 the Swarm, or may join the Swarm 218 if he is not already a member. If he joins 218 a Swarm, he is given the opportunity to grow the Swarm by recruiting 212 new members to the Swarm as heretofore described, and to link 214 the Swarm to related Swarms.

When a Swarm is displayed 208, the buyer may display 220 a list of other buyers that are members of the Swarm as indicated by a members list 615 of the Swarm record 600. The buyer is given the option of sending messages 222 to, or receiving message from, those other buyers.

When a Swarm is displayed 208, the buyer may view a current, or potentially the “best,” pending offer 224 made to that Swarm by sellers he is a member (i.e. created 210 or has previously joined 218) of that Swarm. Offers are located in the offer database 114 (FIG. 1) through linkage of the offers to the offers list 616 of the Swarm 226. While viewing pending offers 24, the buyer is given the option of accepting 228 the offer; if the buyer rejects the offer he is returned to the Swarm display 208. When viewing the offer 224, the buyer is provided with the offer price 802 (FIG. 8), shipping costs 806 or other deliver information from the associated offer record 800 in the offer database 114. In embodiments, the buyer may be shown a detailed description 810 and a digital photograph 812 of the goods to assist with his purchasing decision.

If the buyer accepts 228, the offer, a record of the transaction is recorded in transaction database 115 and linked to a transactions list 530 in the buyer's record 500; the buyer may then view 230 full payment instructions 804, and any other special instructions 808 entered by the seller into the offer record 800. If the buyer has entered shipping information into his profile, this information is made available to the seller as necessary for completing the transaction, if the buyer has not entered this information the buyer is expected to follow seller instructions in the offer for submitting any necessary information, which may include name and shipping address, to the seller. The buyer is then, in one embodiment, removed from the Swarm, and in another embodiment given the option of remaining in 231 the Swarm. The transaction database 115 is accessible by the associated buyers (see 252) and sellers, the records of transactions include details of the relevant offer should the buyer need to re-visit payment instructions 804, shipping details, and price 802. Other useful information n the offer record 800 may include offer expiration date 816, a Swarm link or identifier 818, and a link 820 to the next-best offer.

In an embodiment, after a buyer has accepted 228 an offer, if the seller placed a quantity limit on the offer—such as “Limit by Views” (the number of eSwarmers who view a sales offer), “Limit by Acceptance” (the number of eSwarmers who accept a sales offer) and/or “Limit by Budget” (how much eSwarm charges total whether sales offers are viewed or accepted)—such as when the seller has a limited inventory of an item, a remaining quantity or supply counter 814 in the offer record 800 is decremented 232 and tested to see if the supply count has reached zero 234, if the count has reached zero, any other current or potentially best offer to the Swarm found in offer database 114 is posted 236 to the Swarm. If the buyer does not accept 228 the offer, he is returned to the Swarm display 208 and may choose to return to his list of Swarms 240, his homepage 202, or leave 216 the Swarm.

Posting 236 an offer to the Swarm includes sending notifications to members of the Swarm as recorded in a members' list 615 of the associated Swarm record 600. These notifications are sent according to notification options 518 entered 204 by the buyer into his profile and stored in buyer records 500 of the members.

A buyer may choose to view a list 240 of all Swarms he has joined 218 or created 210, he may then display 208 any of these Swarms.

A buyer may choose to update his mailing lists 242, for example, including email addresses, Facebook® links, and cell-phone text-message numbers form Outlook®. The user may optionally import a mailing list from a list of contacts in Microsoft Outlook®, a Gmail® contact list, a Yahoo® contact list, a Google®, Iphone® (Android®) contact list, or a contact list in a personal organizer format such as Palm® of Blackberry®

A buyer may also choose to search 246 for other buyers by buying interests stated in their profiles, he may then view selected portions of those other buyer's profiles if their profiles do not have the privacy flag 514 set in their profile, and may choose to send messages 222 to those buyers.

A buyer may read and/or reply to, or delete electronic messages 222 that are stored in messages database 118 and linked to his buyer record. He may also send messages to other buyers he knows, to sellers whose offers has accepted, and to system managers.

Finally, a buyer may rate 250 sellers whose offers he has previously accepted 228. The buyer is permitted to rate 250 sellers up to four weeks after accepting an offer so that the rating may be influenced by promptness of shipment, delivery, and quality of goods received.

### Seller Activity

If 410 (FIG. 4) an authenticated 402 user is a seller, a seller's MeSwarm page or personal homepage 302 is displayed. The seller is given the option of editing 304 his profile and account information, and may set up a storefront 306 page that may be searched and displayed by buyers to suggest to those buyers specific goods and services that may be purchased through a Swarm.

The seller is given the option of rating 308 buyers to indicate those who failed to complete transactions, and may read, reply to, or send messages 310 to buyers who have accepted that seller's offers or to the system managers. Sellers also have the option of searching 312 for, and displaying 314, Swarms relating to goods or services that they may be able to supply. Searching may be by browsing Swarms in a category or category and subcategory, by searching for keywords in the Swarm description, or through following related Swarm lists 614 in Swarm records 600. The seller's Swarm display 314 allows the seller to see the Swarm members and the desired goods or services description. The seller's Swarm display 314 differs from a buyer's view primarily in that it gives the seller the choice 316 of whether to make an offer to the Swarm. If 316 the seller wishes to make an offer, the seller's authorization flag 702 is checked 318 in the seller's record 700 (FIG. 7); if the seller is not an authorized seller the seller is given the chance to request 320 authorization as a seller. Other useful data for the seller record 700 may include username password 706, actual name 708, payment instructions 710, list of related Swarms 712, a list of cumulative transactions on the system 714, and a ratings list with evaluations from buyers 716.

If 318 the seller is an authorized seller, the seller may then enter the terms of his offer 322 into an offer record of the offer database 114 and linked to the displayed Swarm; he is then charged 324 for each eSwarmer who “views” his offer and/or “accepts” his offer. The offer terms may include a supply count such that a seller need not become obligated to supply more Swarm members than its inventory will allow, as well as a detailed description of the goods or services and payment or other special instruction for the buyer.

In one embodiment, if 326 a “BidBattle” flag 620 has been set in the Swarm record 600 (FIG. 6) by a Swarm creator or system manager, and the offer is the first offer directed to the displayed Swarm, the offer is held for a predetermined time delay 328 or until a second offer is entered into the system. When the time delay 328 expires, when a second offer is entered, or immediately if the “BidBattle” flag 620 was not set, the lowest offer in the system 100 addressed to the displayed Swarm is posted to the Swarm and member-buyers of the Swarm are notified according to the notification options 518 in their buyer records 500.

In one embodiment, a logged-in seller sees a desirable Swarm. The seller clicks “Make Offer” and enters data that the eSwarm System uses to notify eSwarmers in that Swarm of the offer. From the “Make Offer” page, a seller:
(A) sees he/she will be charged for each Swarmer who views an offer and an additional charge for each Swarmer who accepts an offer;
(B) selects a billing method for this charge (e.g., Limit by Views, Limit by Acceptance, Limit by Budget);
(C) if there is a hit according to the selected billing method, the seller enters payment information and selects payment type (e.g., credit card or billing agency); and
(D) describes the offer by providing name of product/service, offer expiration, and terms of offer, (e.g. price, shipping costs, color, size, and/or restrictions).

A seller may request authorization 320 even if there is no currently pending Swarm for the seller's goods or services.

An authorized 334 seller may also create 336 a Swarm that has no buyer members, the seller enters 338 the description of the goods and services to be sold. The seller may optionally enter an offer 340 to that Swarm that will be held in the offer database 114 until a buyer joins 218 (FIG. 2) the Swarm; at that time the best pending offer (which may be from a different seller) will post 330 to the Swarm.

### Manager Activity

When a user is authenticated 410 (FIG. 4) as a manager, the user is directed to a Manager homepage 411. The Manager may then search and display 412 Swarms, including newly added Swarms and Swarms that have been flagged by users as violations of systems polities. Once the manager has displayed 412 Swarms, he may delete 414 Swarms, modify Swarms including altering product details, set or clear the BidBattle flag, and alter or set expiration dates and default life spans of Swarms and offers. He may also change his mode to buyer mode and create Swarms. The Manager can also edit any Swarm to enhance its presentation, such as to delete the Swarm, correct text or replace an image.

A manager may also display a list of buyers 416, from which he may alter certain details of a buyer record including changing the buyer's password 418 for those buyers who have forgotten their password, and he may block buyers from some or all activities on the system. He may also display a list of sellers 420, from which he may alter certain details of the seller's record including changing the seller's password and setting or clearing the authorized seller record to allow a seller to make offers to a Swarm or to block the seller. A manager may also send and receive messages 422 to buyers and sellers, and my review transactions 424 that have been made on the system. Managers may perform other system maintenance tasks including creating new manager accounts and altering structure of the hierarchical pick lists.

### A Typical Transaction

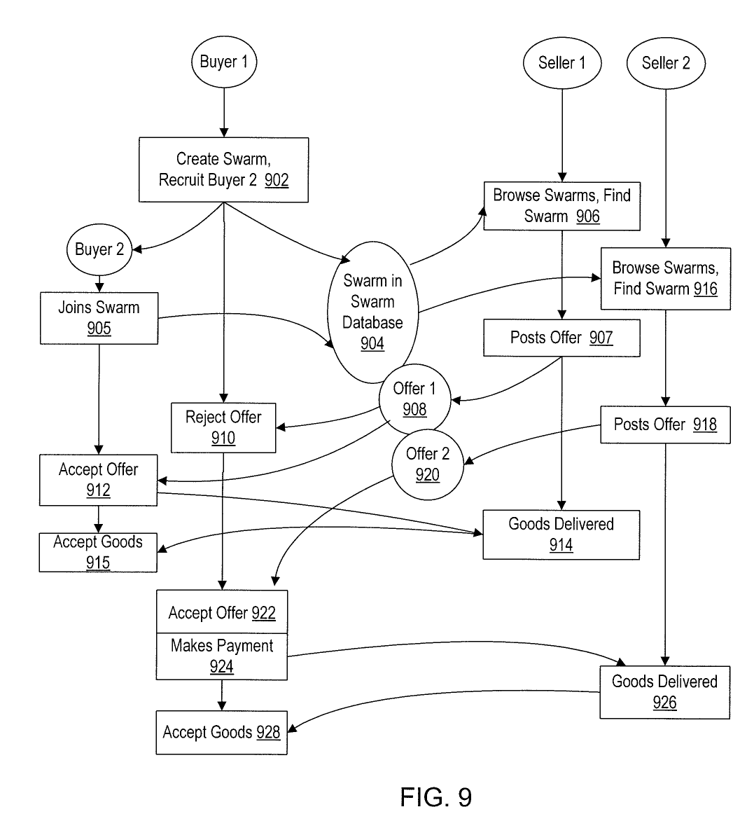

A transaction, as illustrated in FIG. 9 with reference to FIGS. 2 and 3, between buyer and seller will occur after a first buyer creates 210 (FIG. 2), 902 a Swarm 904 for the goods the buyer desires, for example but not limitation a Ford® F-150 Pickup truck located in Colorado, and recruits 212 a second buyer to the system and who then joins 905 the Swarm 904.

A Denver Ford dealer (Seller 1) browses all Swarms for new pickup trucks, looking for those desiring a vehicle in Colorado. He finds 906 the Swarm 904, pays the fee (per “view per “acceptance”) 324, and enters 322 and posts 330/907 an offer 908 for a red F-150 pickup truck to the Swarm at a particular price. The first buyer receives an email notification, the second buyer a text message on his cell phone as per their individual notification options. That offer will be exclusively displayed as “current offer” for a set period of time (such as 48 hours). As soon as one offer is completed, the next offer is presented to buyers whether the 48 hours has expired or not.

The first buyer (Buyer 1) logs into the Swarm 208, and rejects 228, 910 the offer because he really would prefer a blue truck or the price is not low enough. The second buyer (Buyer 2) logs into the Swarm, views 224 the offer, and accepts 228, 912 the offer. The second buyer then views 230 the payment instructions and special instructions—including the dealer's address where he must pick up the pickup. A record of the transaction is entered into transaction data base 116. The offer supply count is decremented 232, and since the count of available pickups of that color and price is now zero 234, this first offer is removed from the Swarm and another offer may then be posted to the Swarm. The eSwarm System subtracts the Swarm population by those eSwarmers who accepted an offer. Those who decline the offer remain in the Swarm.

In complying with the payment and special instructions, the second buyer notifies and meets the dealer, delivers his down payment, the dealer delivers 914 the truck, and the second buyer accepts 915 the truck by driving it off the dealer's lot.

Meanwhile a second dealer (Seller 2) has browsed the available Swarms and has also found the Swarm 916. This dealer has posted 918 a second offer 920 for a blue pickup about which the eSwarm System will notify those who are in the Swarm after the time period (48 hours) for display of the first offer has expired. Buyer 1 then logs into the Swarm and views the second offer 920. Since the blue pickup is desirable to him, he accepts 922 the second offer and makes payment 924 as directed in the offer to the second dealer. The second dealer then delivers 926, the keys to the blue truck to the first buyer, who accepts the goods 928 by driving the blue truck off the second dealer's lot.

While this example F-150 Swarm had only two members, and only two sales, the system herein described has potential to grow very large Swarms and consummate large volumes of sales at potentially large volume discounts. Growth of each Swarm may be exponential as each new Swarm member may attract yet more buyers into the Swarm.

While buyer one may be Swarming direct from a central host for the eSwarm, buyer two may be Swarming via the eSwarm Widget displayed on a third party website.

The foregoing system and method therefore permit potential buyers to associate as a group for collective bargaining with potential sellers.

### Third-Party Website Site Administrator Activity

The foregoing instrumentalities may be variously implemented on a central host or server, or distributed out among a plurality of servers using an eSwarm Widget. In one example, a fashion magazine may host Swarms by category according to a particular manufacturer such as a handbag manufacturer, or a category of manufacturers, such as a plurality of handbag manufacturers.

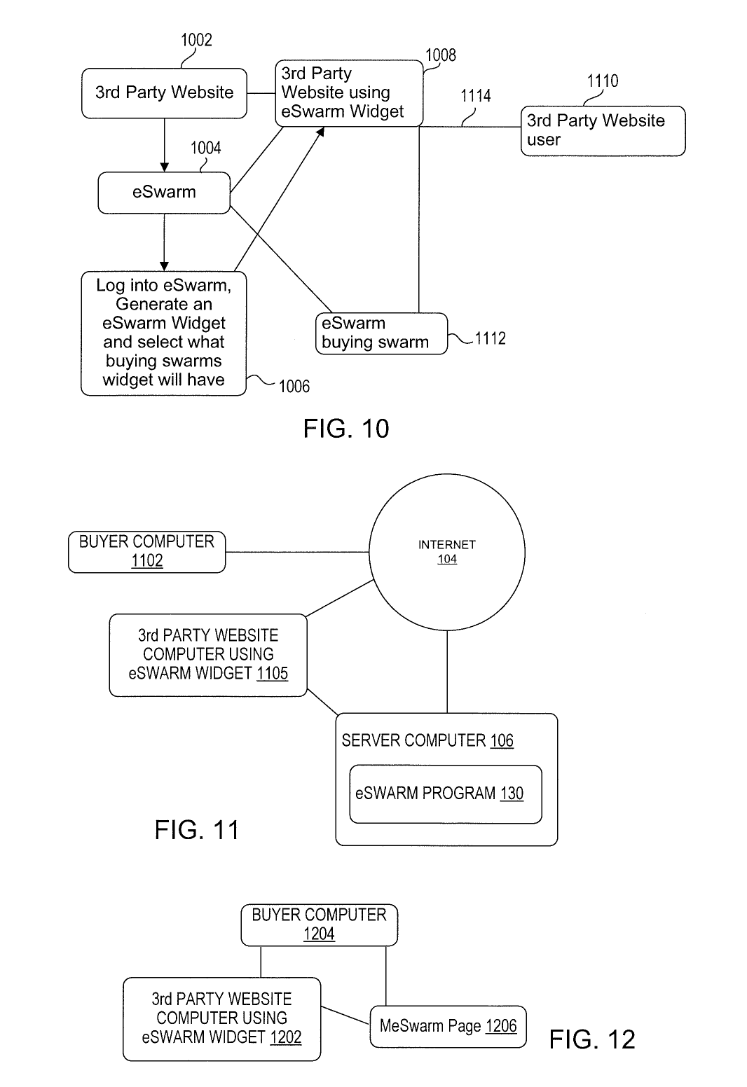

According to an embodiment shown in FIG. 10, in order to implement the functionality on her company's third-party server 1002, a third Party Website Administrator finds the eSwarm central server 1004 then registers with or logs onto the eSwarm System central server 1006. From the site administrator's MeSwarm page on the eSwarm System, the site administrator determines the shape, size and color of the Widget to be displayed on his/her website in the form of an eSwarm Widget. To do so, after designing the Widget, the site administrator clicks “generate code” and eSwarm generates the appropriate code. The site administrator copies that code and, once pasted into her website, the eSwarm Widget appears for use on that website. From her MeSwarm page, the site administrator also determines what Swarms will be displayed in the eSwarm Widget and, potentially, what kind of Swarms may be included on that eSwarm Widget from site users to start Swarms from that eSwarm Widget. The eSwarm Widget is configured to permit users 1110 of the third party website to join Swarms 1112, redirecting such users to the eSwarm System 1004 in a transparent manner such that the appearance to the user may be that of interacting with the third-party website. User interaction with the eSwarm System is as described above, but with suitable controls imposed by the system administrator, such as limiting the available Swarms that the user may access from the third-party website. Thus, although the buyer accesses the eSwarm System from a third-party website, a seller's offer may be communicated to all buyers in the Swarm including buyers who participate in the Swarm through the eSwarm system directly and other buyers who Swarm from other third-party websites.

As shown in FIG. 11, the site administrator's site's users can join Swarms within the Widget from that website. If allowed, that site's users can create Swarms which will be displayed on that website's eSwarm Widget. If a user clicks “create Swarm” they are taken to eSwarm—as if on eSwarm. If that Swarm is a category allowed to be displayed in the site's eSwarm Widget, it will appear in the Widget. If not, it appears on eSwarm.com only. All Swarms created on Widgets appear on eSwarm.com as well as some appearing in a site's eSwarm Widget.

In a particular embodiment of a system 1100 for transacting business over a network, as illustrated in FIG. 11, there are one or many buyers located at buyer computer 1102. The buyer computers are also linked to eSwarm 130 indirectly through one or many third-party websites 1105. The Internet 104, server computer 106, and eSwarm program 130 function identically as described in context of FIG. 1.

Operation of the Widget system is illustrated in the process diagram of FIG. 12. Under control of the machine readable code of the eSwarm program 130 and machine readable code of an operating system, when a user connects to server computer 106 (FIG. 1) through a buyer computer 102 that has connected to a third-party website 1202 using an eSwarm Widget as described above, the buyer 1204 can join any Swarm displayed in the eSwarm Widget. To join a buying Swarm on a Widget, the buyer can register via the eSwarm Widget by the same process as if registering without the Widget, but with the administrator-imposed limitations being imposed through the MeSwarm page or agent 1206, which does a handshake with the third-party server to ascertain the user origin and impose the limitations. The administrator need not necessarily impose any limitations at all.

While the foregoing has been particularly shown and described with reference to particular embodiments thereof, it will be understood by those skilled in the art that various other changes in the form and details may be made without departing from the spirit and hereof. It is to be understood that various changes may be made in adapting the description to different embodiments without departing from the broader concepts disclosed herein and comprehended by the claims that follow.

What is claimed is:

1. A method of doing business comprising:
a. allowing a first individual to start a group for the purpose of purchasing a desired product or a service, the group recorded in a searchable computer database;
b. allowing a second individual to join the group;
c. allowing a potential seller to search the computer database and to submit an offer for product or service to the group, the offer being recorded in a computer databases;
d. allowing an individual selected from the group consisting of the first and the second individual to view and to accept the offer; and
e. consummating a transaction between the individual an the seller based upon the accepted offer with delivery of the product or service,
f. each of the foregoing steps a through e being facilitated by program instructions to assist a network data transaction.

2. The method of claim 1, where the first individual may promote and grow the group by at least two methods selected from the group consisting of sending email, sending text messages, placing a link in a webpage, and combinations thereof.

3. The method of claim 1 further including a step g. of using circuitry to charge the seller an offer fee for presenting the seller's offer to the group.

4. The method of claim 2 further comprising uploading an address list into a database, and wherein promoting the group comprises sending email to a plurality of addresses in the address list.

5. An interactive system for connecting buyers with sellers comprising:
a server having a processor and coupled to receive information from, and transmit webpage information to, buyers and sellers at computers through a computer network;
at least one database in a memory system of the server, the at least one database having a plurality of buyer records each having information on a buyer and a plurality of seller records having information on a seller;
means for receiving a create request from a first buyer of the buyers and creating a group of buyers having interest in purchasing goods, the group in the at least one data base and linked to a buyer record having information on the first buyer;
means for receiving a search request from a second buyer, for searching a plurality of groups to locate the group in response to the search request, and for displaying to the second buyer information from the group;
means for receiving a join request from a second buyer of the buyers and for linking a buyer record having information on the second buyer to the group;
machine readable code within the server for receiving a search request from a seller, for searching a plurality of groups to locate the group in response to the search request, and for displaying to the seller information from the group
machine readable code within the server for receiving a make-offer request from the seller, for creating an offer record in the at least one database, for recording offer information in the offer record, for linking the offer record to the group, and for notifying the buyers of the existence of the offer record; and
machine readable code within the server for displaying the information from the offer record to a buyer selected from the group consisting of the first buyer and the second buyer.

6. The interactive system of claims 5, further comprising means for receiving a create Widget request from a third-party website administrator and creating an eSwarm Widget for the site's users to be able to participate in eSwarm Swarms.

7. The system of claim 5 wherein the buyer record having information on the first buyer comprises a mailing list, and wherein the machine readable code within the server further comprises machine readable code for receiving an upload of email addresses into the mailing list.

8. In an interactive system for conducting commerce over the Internet, the improvement comprising:
means for hosting a system that forms swarms of a community of users as buyers that share common purchasing interests and connects the swarms with sellers that may meet those purchasing interests; and
means for accepting additional buyers for inclusion in the Swarm through a process of redirection from a server that is not part of the means for hosting.
